(19) United States
(12) Patent Application Publication
(10) Pub. No.: US 2024/0149428 A1
(43) Pub. Date: May 9, 2024

(54) QUICK RELEASE SAW HORSE WITH SIDE INDEPENDENT FOLDING LEGS

(71) Applicant: AFFINITY TOOL WORKS, LLC, Troy, MI (US)

(72) Inventors: Emanuel H. Szumer, Bondi Junction (AU); Edward D. Adkins, Truth or Consequences, NM (US); Rod Bonham, Decatur, TX (US); Michael Ursell, Bloomfield Hills, MI (US); Kenneth Neilson, Rochester Hills, MI (US)

(21) Appl. No.: 18/386,556

(22) Filed: Nov. 2, 2023

Related U.S. Application Data
(60) Provisional application No. 63/422,242, filed on Nov. 3, 2022.

(51) Int. Cl. B25H 1/06

(52) U.S. Cl. CPC B25H 1/06

(57) ABSTRACT

A saw horse having folding legs which can be unfolded for use and folded for transportation and storage. The sawhorse legs can be unfolded by releasing a single latch and allowing the weight of the legs to unfold. To fold the legs into a storage position, either pair of legs can be rotated to the folded position and then the other legs can be rotated. Which side is initially chosen for closing is not important due to the leg mounting system.

### RELATED APPLICATIONS

This application claims the benefit of U.S. Provisional Application Ser. No. 63/422,242 filed on Nov. 3, 2022, which is incorporated herein by reference in its entirety.

### TECHNICAL FIELD

This invention relates generally to saw horses and more particularly to saw horses that have folding legs that can be unfolded for use and folded for transportation and storage.

### BACKGROUND OF THE INVENTION

The present invention generally relates to sawhorses. Saw horses are well known and generally employ a stretcher and legs to support the stretcher. These sawhorses come in any number of sizes and shapes, but typically have four legs that are fixed in the support position or can be folded or telescoped to a closed position. Some of these known Examples of applicant's tool stands can be found in U.S. Design Pat. Nos. D623,672 and D549,749 and U.S. patent Ser. No. 10/093,016.

The difficulty with typical sawhorses is that they can be large and unwieldy. If the legs are fixed in place, it can be difficult to move them from job to job. This is true even if wheels are provided to roll the saw horse. Folding legs and extendible legs can be cumbersome. Each leg has to be extended or folded out to use the sawhorse and collapsed to transport. Typical sawhorses are awkward with folding legs that require a specific set of legs to be folded first and then the second set of legs can be folded.

What is needed is a sawhorse that is more compact and can be easily transported. Also, a sawhorse that has legs that can be easily and quickly deployed and then folded without regard to which set of legs has to be folded first. It is also desirable to have an economical saw horse.

### SUMMARY OF THE INVENTION

In general terms, this invention provides a saw horse having folding legs which can be unfolded for use and folded for transportation and storage. The sawhorse legs can be unfolded to a working position by releasing a single latch and allowing the legs to unfold by their weight. To fold the legs into a storage position, either one of the pair of legs can be pivoted or rotated to the folded position and then the other legs can be pivoted or rotated. It doesn't matter which side is initially chosen due to the innovative leg mounting system.

The sawhorse is an economical sawhorse that has quick deploying legs with quick folding legs. The legs can freely fall to the open position and spring to the open V-position by an optional biasing member. The legs rotate with respect to the stretcher on a lateral pivot axis and pivot with respect to a connector that attaches the legs to the lateral pivot axis.

To close the sawhorse the legs are pushed together so that they closely adjoin each other. It is important to note that either pair of legs can be closed first. This makes closing the legs easier. To close, the legs pivot with respect to the connector and then pivot around the lateral pivot axis. The legs can be rotated to the closed position between the sidewalls of the stretcher and the latch can be closed.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the present invention in the folded closed position.

FIG. 2 is a perspective view of the present invention in the unfolded open position.

FIG. 3 is a partial perspective side view of the present invention in the unfolded open position.

FIG. 4 is a partial perspective end view of the present invention in the unfolded open position.

FIG. 5 is a partial perspective bottom view of the present invention in the unfolded open position.

FIG. 6 is a partial perspective bottom view of the present invention in the unfolded open position.

FIG. 7 is a partial perspective top view of the present invention in the unfolded open position with the stretcher top cutaway.

### DETAILED DESCRIPTION OF A PREFERRED EMBODIMENT

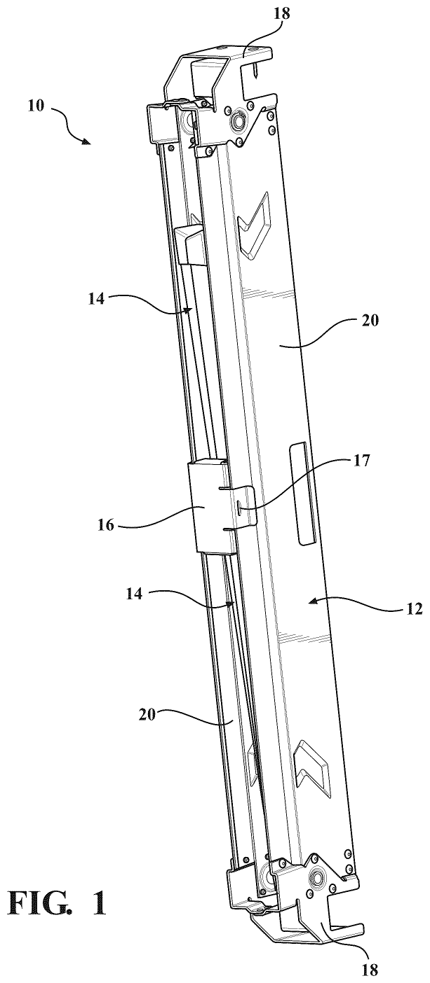

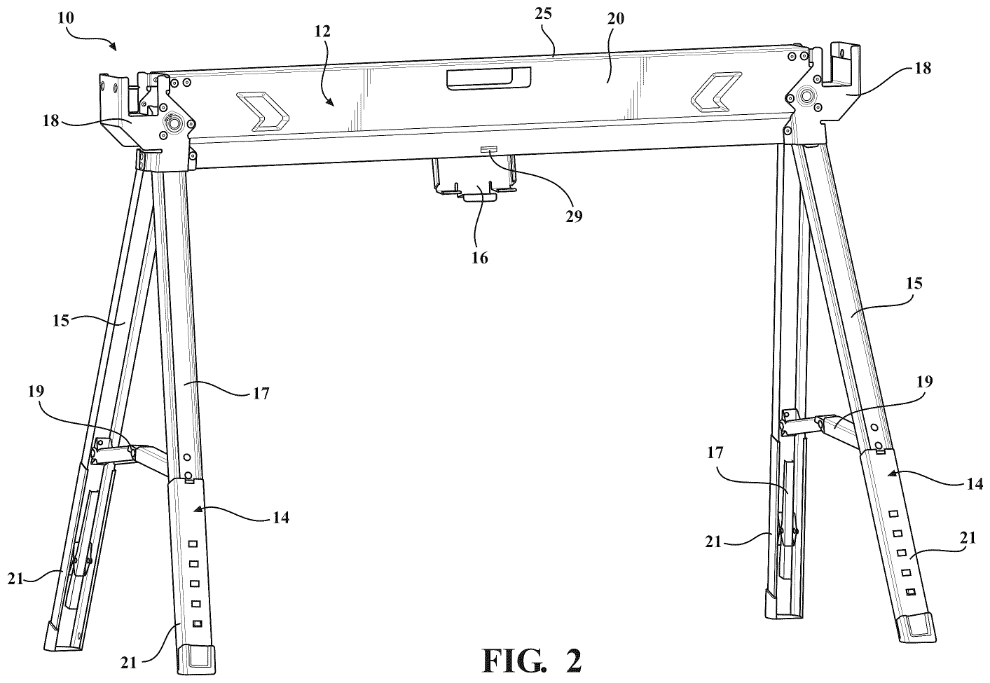

With reference to FIG. 1 the sawhorse of the present invention is shown generally at 10. Sawhorse 10 includes a stretcher 12 with first and second supports 14 mounted to each respective end of the stretcher 12. FIG. 1 illustrates the sawhorse 10 in the folded position with the supports 14 folded and FIG. 2 illustrates sawhorse 10 with the supports 14 unfolded for use. As can be seen in FIG. 2, the sawhorse 10 resembles a typical sawhorse. In FIGS. 1 and 2, an end cap 18 is mounted to both ends of the stretcher 12. In the other drawings, the end cap 18 has been removed for clarity in the description.

As illustrated in FIG. 2, each of the supports 14 have two leg members 15 and 17. The leg members 15 and 17 form a V-shape when in the use position. A collapsible crossbar or brace 19 assists in maintaining the legs in the open V-shaped position. Additionally, as shown in FIG. 2, each of the leg members 15 and 17 can have adjustable lower legs sections 21 that allow the length of each leg 15 and 17 to be adjusted. This facilitates having the stretcher 12 at the correct height as well as being able to adjust the leg heights for uneven surfaces.

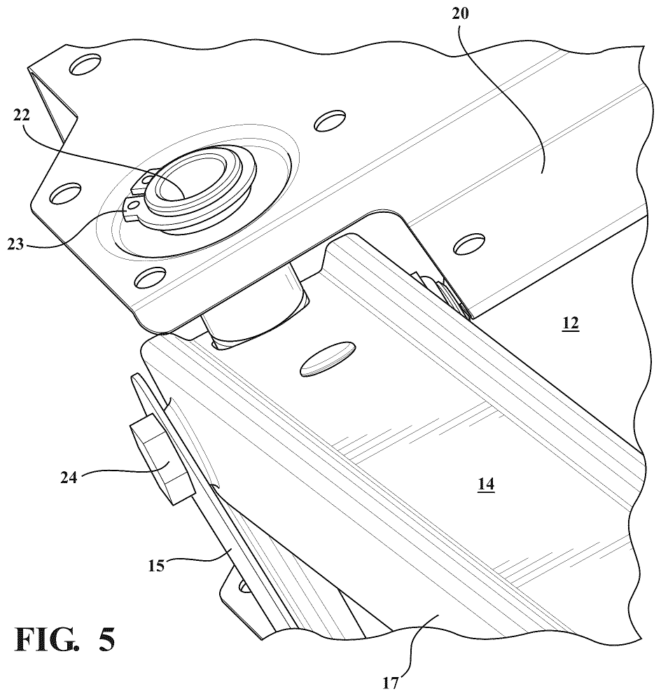

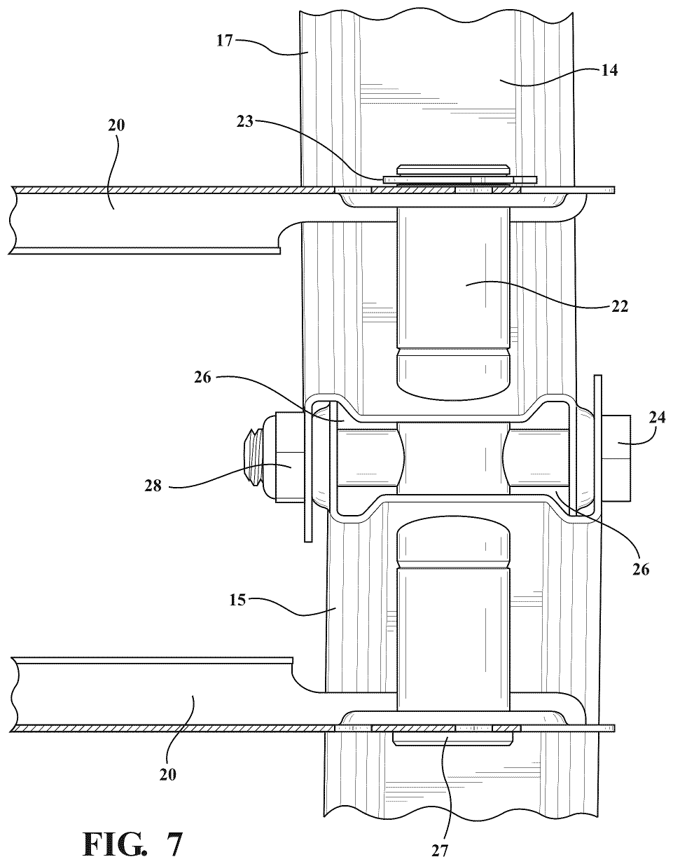

As illustrated in FIGS. 1 through 7, the stretcher 12 has side walls 20 and a top 25. As illustrated in FIG. 1, the leg members 15 and 17 collapse to the closed or storage position within the side walls 20. To fold the legs 15 and 17, the crossbar 19 is collapsed and the legs 15 and 17 are pivoted with respect to one another so that they are adjoining each other. The legs 15 and 17 are then pivoted with respect to the stretcher 12 to a position between the sidewalls 20. Once positioned in the folded position, the latch 16 is engaged to hold the support members 14 in the stored position.

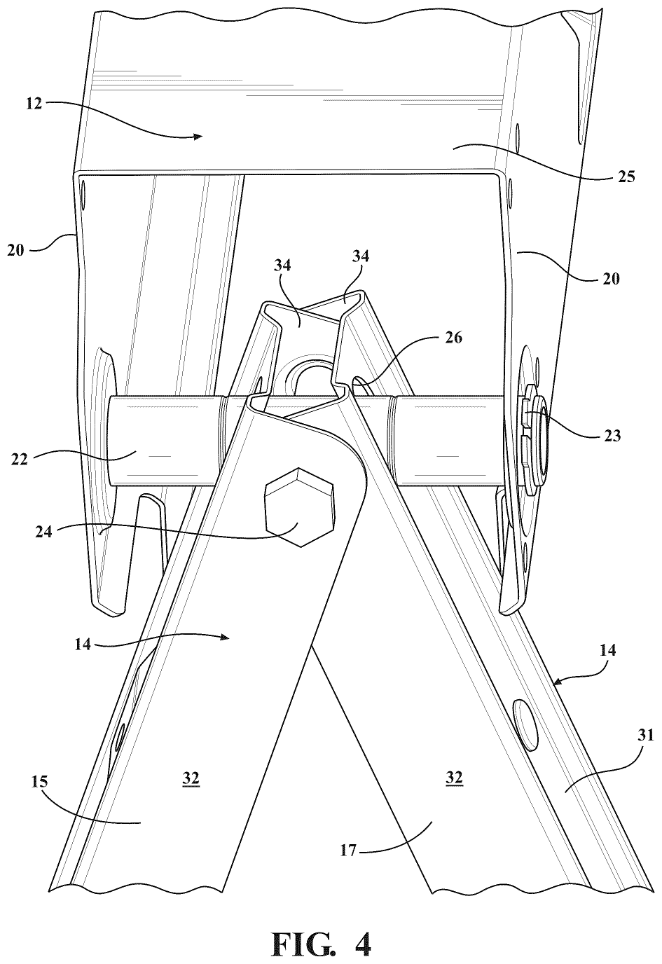

As shown in FIG. 4, the leg members 15 and 17 have a surface 31 sides flanges 32 and 34 as shown in the figures that closely adjoin each other and overlap when in the closed position. In other words, one leg member 15 nests with the adjacent leg 17.

As will be discussed in detail below, either leg support 14 can be closed first and the other leg support 14 closed after. The closing of the supports 14 is discretionary by the user and they fold independently of one another. Stated differently, neither of the legs has to be folded first, either can be folded to start closing the sawhorse 10 and then the other can be folded into the stored position.

To release the support members and unfold them to the working position, the latch 16 is released and the weight of the support members 14 rapidly deploy them into position. As illustrated, the latch 16 is positioned in the center of the stretcher 12 so that only one latch is needed and allows for more rapid release. All a user has to do is engage the optional crossbar 19 to fully open legs 15 and 17. It should be appreciated that the brace 19 could be biased by a spring to make the release of the support members from storage to use completely automatic.

It should also be appreciated that other types of locks could be used. The present illustrated latch 16 has a notch 17 that engages a tab 29 on the stretcher 12, see FIGS. 1 and 2. The placement of the notch and latch could be reversed, or other latches such as a strap, a rubber member around the stretcher 12, a threaded member locking member etc.

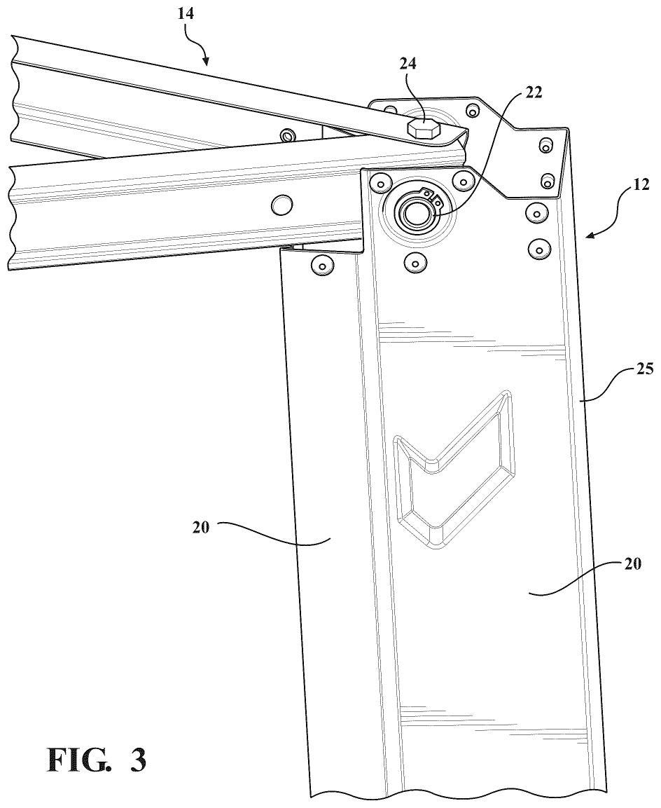

With reference to FIGS. 3 through 7, the leg members 15 and 17 are mounted on a lateral pivot axis 22. The lateral pivot axis 22 pivots with respect the walls 20. As illustrated, the lateral pivot axis 22 is mounted to the walls 20 of the stretcher 12 with a snap ring 23. The other end of the lateral pivot axis 22 has a head 27 that engages the wall 20, but could have a snap ring 23. Many other connectors could obviously be used for mounting the lateral pivot axis 22 to the stretcher 12, such as for example bolts, a bearing, deforming the ends of a tube or shaft, etc.

A connector 24, illustrated as a longitudinal mounting bolt, extends through the legs 15 and 17 and through the lateral pivot axis 22 to attach the legs 15 and 17 to the pivot axis 22. The pivot axis 22 allows the legs to rotate longitudinally with respect to the stretcher 12. The connector 24 allows the legs 15 and 17 to pivot and collapse with respect to each other and scissor to the closed position. The legs have elongated slots 26, to allow them to pivot on the connector 24 without interference with the lateral pivot axis 22 when they are opening and closing.

The connector 24 is shown as a bolt with a nut 28, but could be any connector for connecting the legs 15 and 17 to the lateral pivot axis 22, for example a shaft with a cotter pin, a rod with a head and a snap ring, a pair of connectors integrally formed on the lateral pivot axis 22, etc.

As shown in FIG. 2, the end caps 18 provide a stop for the legs 15 and 17 when they are released and opened.

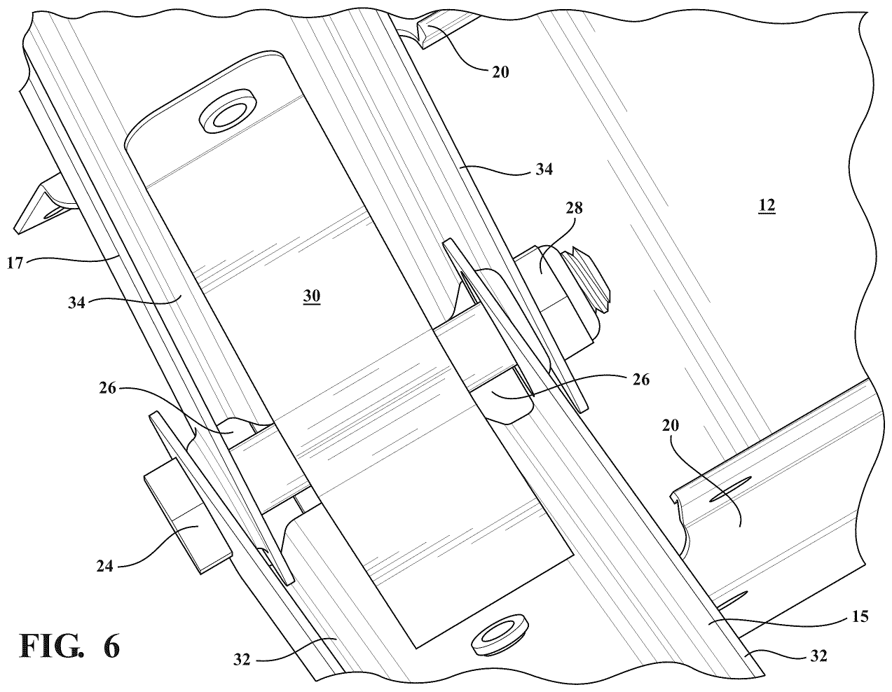

With reference to FIG. 6, a spring 30 is shown interconnected between the legs 15 and 17 on each side of the sawhorse 10. The spring 30 is shown as a leaf spring, which normally forces the legs to the open position. In this way, once the lock 16 is released, the legs can fall by gravity to the open position and the spring 30 forces them to the V-shaped open position. The spring 30 could be a different biasing device other than a leaf spring, such as a coil spring, a spring loaded longitudinal mounting bolt, etc.

As will be appreciated, the present sawhorse 10 is an economical sawhorse that can quickly deploy the folded legs 15 and 17. The legs 15 and 17 can freely fall to the open position and be spring to the open V-position by spring 30. The sawhorse 10 in operation merely requires a latch 16 to be released. The legs 15 and 17 rotate with respect to the stretcher 12 on the lateral pivot axis 22. Once the legs 15 and 17 are free of the stretcher 12, the biasing device, leaf spring 30, forces the legs 15 and 17 into the V-shape as the legs 15 and 17 are deploying. The legs 15 and 17 pivot to the open V-shape with respect to the connector 26.

To close the sawhorse 10, the legs 15 and 17 are pushed together so that the walls 32 and 34 as shown in the FIG. 6, closely adjoin each other or in other words one leg nests with respect to the adjacent leg 14. It is important to note that either leg support 14 can be closed first. This makes closing the legs 15 and 17 easier. To close, the legs 15 and 17 pivot with respect to the connector 24 and then pivot around the lateral pivot axis 22. When the legs 15 and 17 are rotated to the closed position between the sidewalls 20, the latch 16 can be closed. It should be understood that due to the independent lateral pivot axis 22 and the connector 24 either support 14 can be closed first and the other leg support 14 closed to rest on top of the first support 14.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A sawhorse comprising:
a stretcher having a first end and a second end;
a first support mounted to said first end of said stretcher and a second support mounted to said second end of said stretcher, each of said first and second support members having first and second legs, each of said first and second legs having a proximal end and a distal end;
a first lateral pivot axis mounted to said first end of said stretcher and a second lateral pivot axis mounted to said second end of said stretcher, said first and second pivot axes being adapted to pivot with respect to such stretcher;
first and second connectors, said first connector pivotally connecting said proximal end of said first and second leg members of said first support to said first lateral pivot axis, and said second connector pivotally connecting said proximal ends of said first and second legs of said second support to said second lateral pivot axis;
whereby, said first and second legs pivot with respect to their said respective connector from a first position wherein said first and second legs are adjacent, to a second position wherein said distal ends of said respective first and second legs are spaced apart, said first and second legs of said first and second supports being rotatable about said respective lateral pivot axis to move between an unfolded position and a folded position.

2. The sawhorse of claim 1, wherein said stretcher has a top and sides defining a cavity, said first and second support members being housed in said cavity when in said folded position.

3. The sawhorse of claim 1, wherein said first connector extends through said proximal ends of said first and second legs of said first support and through said first lateral pivot axis.

4. The sawhorse of claim 3, wherein said second connector extends through said proximal ends of said first and second legs of said second support and through said second lateral pivot axis.

5. The sawhorse of claim 1, wherein said first lateral pivot axis extends through said proximal ends of said first and second legs of said first support and said second lateral pivot axis extends through said proximal ends of said first and second legs of said second support.

6. The sawhorse of claim 3, wherein said first lateral pivot axis extends through said proximal ends of said first and second legs of said first support.

7. The sawhorse of claim 4, wherein said first lateral pivot axis extends through said proximal ends of said first and second legs of said first support and said second lateral pivot axis extends through said proximal ends of said first and second legs of said second support.

8. The sawhorse of claim 1, further including a slot in said first and second legs of said first support.

9. The sawhorse of claim 3, further including a slot in said first and second legs of said first support.

10. The sawhorse of claim 4, further including a slot in said first and second legs of said first support.

11. The sawhorse of claim 4, further including a slot in said first and second legs of said first support and said second support.

12. The sawhorse of claim 1, further including a spring bias mounted between said first and second legs of said first and second supports.

13. The sawhorse of claim 12, wherein said spring bias is a leaf spring.

14. The sawhorse of claim 1, wherein said connector is a bolt.

15. The sawhorse of claim 1, wherein said first and second legs of said first and second supports have a body defined by a surface and a first side flange and second side flange.

16. The sawhorse of claim 15, wherein said side flanges nest when said first and second legs are adjacent in said folded position.

17. The sawhorse of claim 15, wherein said first flange of said first leg overlaps said first flange of said second leg and said second flange of said first leg overlaps said second flange of said second leg when said first and second legs are in said folded position.

18. A sawhorse comprising:
a stretcher having a first end and a second end;
a first support mounted to said first end of said stretcher and a second support mounted to said second end of said stretcher, each of said first and second support members having first and second legs, each of said first and second legs having a proximal end and a distal end;
a first lateral pivot axis mounted to said first end of said stretcher and a second lateral pivot access mounted to said second end of said stretcher, said first and second pivot axes being adapted to pivot with respect to said stretcher;
first and second connectors, said first connector pivotally connecting said proximal end of said first and second leg members of said first support to said first lateral support, and said second connector pivotally connecting said proximal ends of said first and second legs of said second support to said second lateral support;
said first lateral pivot axis extends through said proximal ends of said first and second legs of said first support and said second lateral pivot axis extends through said proximal ends of said first and second legs of said second support;
said first connector extends through said proximal ends of said first and second legs of said first support and through said first lateral pivot axis;
said second connector extends through said proximal ends of said first and second legs of said second support and through said second lateral pivot axis;
whereby, said first and second legs pivot with respect to their said respective connector from a first position wherein said first and second legs are adjacent, to a second position wherein said distal ends of said respective first and second legs are spaced apart, set first and second legs of said first and second supports being rotatable about said respective lateral pivot supports to move between an unfolded position and a folded position.

19. The sawhorse of claim 18, further including a slot in said first and second legs of said first support and said second support.

20. The sawhorse of claim 18, wherein said stretcher has a top and sides defining a cavity, said first and second support members being housed in said cavity when in said folded position.
